(19) United States
(12) Patent Application Publication
(10) Pub. No.: US 2020/0074562 A1
(43) Pub. Date: Mar. 5, 2020

(54) SYSTEMS AND METHODS FOR GENERATING PRODUCT-MERCHANT DATA LINKS

(71) Applicant: AMERICAN EXPRESS TRAVEL RELATED SERVICES COMPANY, INC., New York, NY (US)

(72) Inventors: Karl R. Johnson, Phoenix, AZ (US); Pradeesh Unni Krishnan, Tempe, AZ (US); Scott A. Nitschke, Cave Creek, AZ (US); Sameer Puranik, Phoenix, AZ (US); Anand Vijai Mavelipatty Rangasamy, Phoenix, AZ (US)

(73) Assignee: AMERICAN EXPRESS TRAVEL RELATED SERVICES COMPANY, INC., New York, NY (US)

(21) Appl. No.: 16/115,460

(22) Filed: Aug. 28, 2018

(51) Int. Cl. G06Q 40/00; G06F 17/30

(52) U.S. Cl. CPC G06Q 40/12; G06F 17/30345

(57) ABSTRACT

A system for generating product-merchant data links is disclosed. The system may receive a request to generate a product-merchant data linkage. The system may receive a raw data set comprising unlinked records and may sort the raw data set into spend data and non-spend data. The system may generate the product-merchant data linkage based on a matching logic and the spend data. The system may construct a linked data set wherein the unlinked records are linked on the basis of the product-merchant data linkage.

### FIELD

The present disclosure generally relates to systems and methods for aggregating and associating data across databases.

### BACKGROUND

The technical problem includes large data sets which may exist in various sizes and organizational structures. With big data comprising data sets as large as ever, the volume of data collected incident to the increased popularity of online and electronic transactions continues to grow. For example, billions of records (also referred to as rows) and hundreds of thousands of columns worth of data may populate a single table. The large volume of data may be collected in a raw, unstructured, and undescriptive format in some instances. However, traditional relational databases may not be capable of sufficiently handling the size of the tables that big data creates.

As such, the massive amounts of data in big data sets may be stored in numerous different data storage formats in various locations to service diverse application parameters and use case parameters. Data variables resulting from complex data transformations (e.g., model scores, risk metrics, etc.) may be central to deriving valuable insight from data driven operation pipelines. Additionally, insights may be gained from functional linkages between operational data. Many of the various data storage formats use transformations to convert input data into output variables. These transformations are typically hard coded into systems.

Therefore, retroactively determining the evolution of individual variables may be difficult, as retracing the layers of transformations for a given variable may be difficult and time consuming. Furthermore, different data storage formats and transformation operations may obscure functional linkages between data, dissociate pervious linkages and/or may make generating novel linkages difficult. Access to such data may be restricted and layers of derivation may make tracking such data difficult. Furthermore, duplicative output data is frequently generated. Duplicative output data may be generated using processing and storage resources, but the duplicative data may be difficult to detect and prevent.

### SUMMARY

In various embodiments, systems, methods, and articles of manufacture (collectively, the “system”) for generating product-merchant data links are disclosed. In various embodiments, the system may receive a request to generate a product-merchant data linkage. The system may receive a raw data set comprising unlinked records and may sort the raw data set into spend data and non-spend data. The system may generate the product-merchant data linkage based on a matching logic and the spend data. The system may construct a linked data set, wherein the unlinked records are linked on the basis of the product-merchant data linkage. In various embodiments, the system may also match the unlinked records on the basis of a transaction identifier, and may link a card receivable system record, a merchant payable system record, and a settlement system record where the transaction identifier matches between each of the card receivable system record, the merchant payable system record, and the settlement system record. The system may store the linked records as match data.

The system may link the merchant payable system record and the settlement system record, where the transaction identifier matches between the merchant payable system record and the settlement system record. The system may link the card receivable system record and the settlement system record where the transaction identifier matches between the card receivable system record and the settlement system record. The system may link the card receivable system record and the merchant payable system record where the transaction identifier matches between the card receivable system record and the merchant payable system record. The system may store the linked records as match data. The system may classify a plurality of unlinked card reliable system records, settlement system records, and merchant payment system records and store the classified unlinked records as match data. The system may link the match data to at least one of a card product identifier, a merchant data, or a customer data. The system may determine a discount revenue allocated to a card product and a merchant based on the match data

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating various system components of a system for generating product-merchant data links, in accordance with various embodiments; and

FIG. 2 illustrates a process flow for generating product-merchant data links, in accordance with various embodiments.

### DETAILED DESCRIPTION

The detailed description of exemplary embodiments herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

In various embodiments, the system may provide a greater level of sophistication and control for big data systems. For example, relating records of interest may be spread across multiple storage systems and formats with limited understanding of where records are stored and how they may be related. In this regard, relationships between records of interest may be ‘hidden’ by gaps in record formatting between the multiple systems and/or asynchronous entry of relating records. While prior art systems typically demand multiple transformations of raw data or probabilistic models for correlating records of interest where gaps exist in raw data, the current system may define direct links between relating records of interest based on existing record elements to eliminate or reduce gaps and reduce user reliance on data variables to relate records. In this regard, the system may also reduce the cost of development or system processing time for data mining by reducing data transformations and not requiring additional hardware development or demanding additional information flow. The system may increase data reliability or accuracy by reducing reliance on probabilistic models for relating records of interest. The system may also reduce redundant input requests, thereby reducing a demand for system resources. The system may simplify data mining and enhance user experience by decreasing a number of user interactions and enable observation of previously hidden relationships between records of interest. Benefits of the present disclosure may apply to any suitable use of big data analytics. For example, the present disclosure may apply in dispute contexts, as well as in information requests or support contexts.

This process improves the functioning of the computer. For example, by decreasing requests for additional variables or probabilistic model processing, data analysis may be expedited. Similarly, the process increases the reliability and speed of data presentation by enabling direct linkages between records of interest on the basis of existing elements. In various embodiments the technical solution is a one-to-one tie enabled between the customer information and the data generated by a card receivables system, a settlement system, and a merchant payable system that increases the reliability and speed of transaction analysis. In this regard, by transmitting, storing, and/or accessing data using the processes described herein, the security of the data is improved and fraud is reduced, which decreases the risk of the computer or network from being compromised. Such improvements also increase the efficiency of the network by reducing the portion of transaction volume comprising fraudulent transactions. In various embodiments, linking and storing using the processes described herein significantly reduces back end processing and reduces processing time required to determine relationships between card products and merchants. Probabilistic model processing and correlation of interest may be computationally resource intensive. In this regard, the processes may decrease processing overhead of computing systems comprising a matching algorithm for relating records. In various embodiments, the processes described herein may increase network availability by reducing front end and back end process calls. In this regard, the processes may save processing resources including CPU time, memory resources, and network resources.

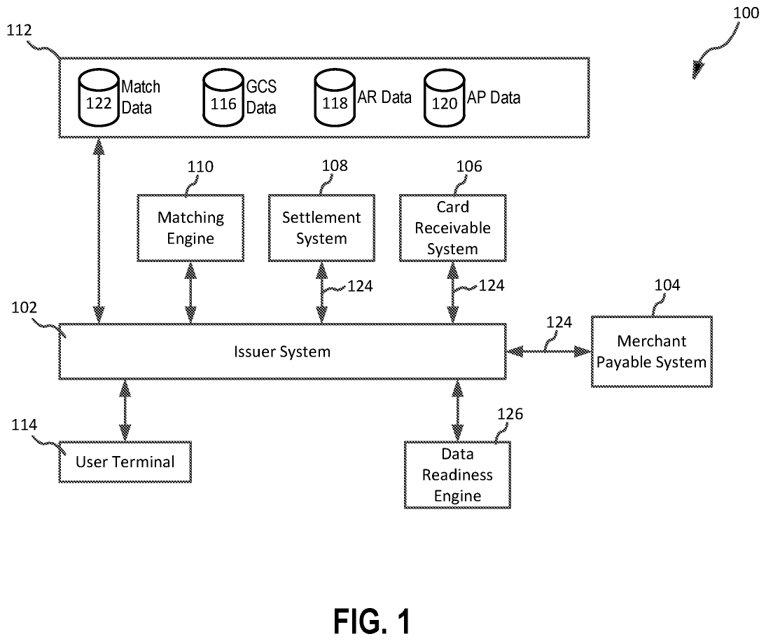

In various embodiments, and with reference to FIG. 1, a system 100 may comprise an issuer system 102, a merchant payable system 104, a card receivable system 106, and a settlement system 108. In various embodiments, issuer system 102 may further comprise a matching engine 110 which may comprise a matching logic, a database 112, and a user terminal 114, and a data readiness engine 126. Any of these components may be outsourced and/or be in communication with issuer system 102 via a network.

In various embodiments, database 112 may comprise any number of data elements or data structures such as GCS data 116, AR data 118, AP data 120, and match data 122. User terminal 114 may comprise software and/or hardware in communication with issuer system 102 via a network comprising hardware and/or software configured to allow a transaction account owner, a user, and/or the like, access to issuer system 102. User terminal 114 may comprise any suitable device that is configured to allow a user to communicate with a network and issuer system 102. User terminal 114 may include, for example, a personal computer, personal digital assistant, cellular phone, kiosk, and/or the like and may allow a user to transmit a request to generate a product-merchant data linkage. System 100 may be computer based, and may comprise a processor, a tangible non-transitory computer-readable memory, and/or a network interface, along with other suitable system software and hardware components. Instructions stored on the tangible non-transitory memory may allow system 100 to perform various functions, as described herein.

In various embodiments, issuer system 102 may be configured as a central network element or hub to access various systems, engines, and components of system 100. Issuer system 102 may comprise a network, computer-based system, and/or software components configured to provide an access point to various systems, engines, and components. Issuer system 102 may be in operative and/or electronic communication with issuer system 102, merchant payable system 104, card receivable system 106, settlement system 108, matching engine 110, database 112, data readiness engine 126, and/or user terminal 114. In this regard, issuer system 102 may allow communication from user terminal 114 and database 112 to systems, engines, and components of system 100. In various embodiments, issuer system 102 may receive raw transaction data 124 comprising transaction records from each of settlement system 108, card receivable system 106, and merchant payable system 104.

In various embodiments, database 112 may be configured to store and maintain data relating to merchant payable system 104 (i.e., a merchant payable system record), such as transaction data 124, as AP data 120. For example, AP data 120 may comprise data elements such as a card account number, a merchant identification, a merchant name and address, a merchant channel, a merchant domicile, an acquirer country, a transaction identifier, a transaction date, a transaction processing date, a discount revenue earned on the transaction, a merchant adjustment code, a merchant adjustment description, a merchant adjustment amount, a merchant adjustment currency, and/or the like. AP data 120 may further comprise non-spend data such as a fee type, a fee amount, a fee currency, a fee settlement amount, a fee settlement amount currency, and a fee effective date. In various embodiments, a transaction identifier may be a unique number having a one-to-one relationship with a particular transaction record. Database 112 may store the AP data 120 using any suitable technique described herein or known in the art. AP data 120 may be in operative and/or electronic communication with issuer system 102, merchant payable system 104, card receivable system 106, settlement system 108, matching engine 110, data readiness engine 126, database 112, and/or user terminal 114. In various embodiments, AP data 120 may be written to database 112 in response to a request to generate a product-merchant data linkage, a transaction initiation request, or as part of an issuer system 102 scheduled task.

In various embodiments, database 112 may be configured to store and maintain data relating to card receivable system 106 (i.e., a card receivable system record), such as transaction data 124, as AR data 118. For example, AR data 118 may comprise data elements such as the card account number, a card account type, a card member name and address, a card member identifier, a card member vintage, a card member account identifier, a card account vintage, a card product identifier, a card member domicile, a card issuer country, market, or legal entity, a channel, a client identifier, the transaction identifier, an amount billed to the card member for each transaction, an adjustment code, an adjustment description, an adjustment amount, an adjustment currency, a remittance type, a remittance description and name, a remittance date, a remittance amount, a remittance currency, and/or the like. AR data 118 may further comprise non-spend data such as a cash advance amount, an annual card fee, a finance charge, interest fees, insurance fees, service fees, a fee type code, a fee description and name, a fee amount, a fee currency, a fee effective date, and/or the like. In various embodiments, the card product identifier may be a unique identifier associated with a particular card product issued by a financial institution such as a credit card. For example, a card product may be a cash back card, or a rewards card, a loyalty card, and/or the like and may comprise any number of features, incentives, rewards, services, interest rates, credit limits, and/or the like. In this regard, the card product identifier may be defined by the unique features of a card product. Database 112 may store the AR data 118 using any suitable technique described herein or known in the art. AR data 118 may be in operative and/or electronic communication with issuer system 102, merchant payable system 104, card receivable system 106, settlement system 108, matching engine 110, data readiness engine 126, database 112, and/or user terminal 114. In various embodiments, AR data 118 may be written to database 112 in response to a request to generate a product-merchant data linkage, a transaction initiation request, or as part of an issuer system 102 scheduled task.

In various embodiments, database 112 may be configured to store and maintain data relating to settlement system 108 (i.e., a settlement system record), such as transaction data 124, as GCS data 116. For example, GCS data 116 may comprise data elements such as the card account number, an amount billed to the card member and a currency of billing, a submission amount and a currency, a merchant settlement amount and the currency, a foreign exchange fee, a date of the charge, a transaction date, the merchant identifier, the transaction identifier, a transaction received date, and/or the like. Database 112 may store the GCS data 116 using any suitable technique described herein or known in the art. GCS data 116 may be in operative and/or electronic communication with issuer system 102, merchant payable system 104, card receivable system 106, settlement system 108, matching engine 110, data readiness engine 126, database 112, and/or user terminal 114. In various embodiments, GCS data 116 may be written to database 112 in response to a request to generate a product-merchant data linkage, a transaction initiation request, or as part of an issuer system 102 scheduled task.

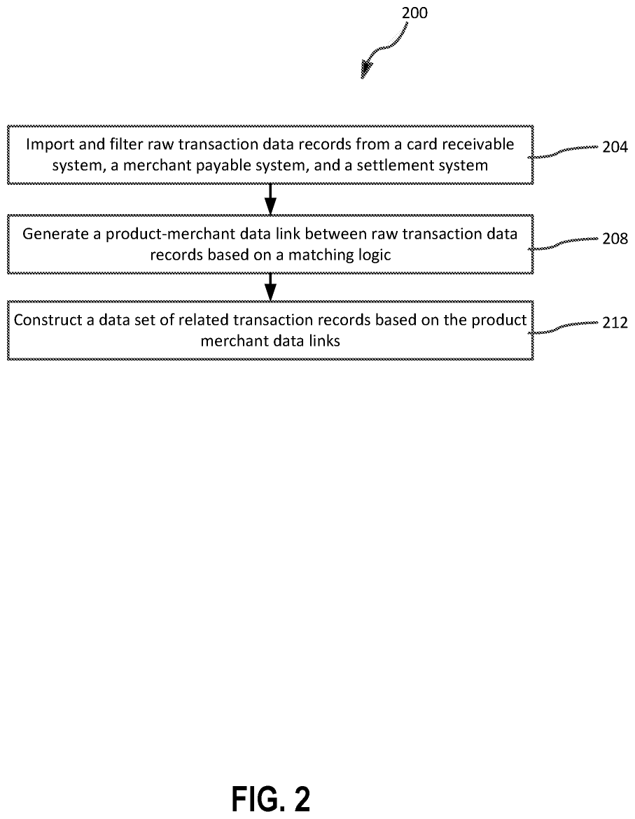

In various embodiments, and with additional reference to FIGS. 1 and 2, method 200 of generating a product-merchant data linkage may include importing and filtering raw transaction data records from a card receivable system, a merchant payable system, and a settlement system (step 204). Issuer system 102 may receive a request to generate a product-merchant data linkage from user terminal 114 or a scheduling system which may periodically execute a command to request generation of a product-merchant data linkage. The request to generate the product-merchant data linkage may be from an user command, a business event, or process internal to issuer system 102. If the request is process-based, it may be set up to execute based on a schedule or external event. If the request is user command based, it may be requested for a specific day, specific market, specific merchant payable system, card receivable system and/or settlement system. Merchant payable system 104, card receivable system 106, and settlement system 108 may provide raw transaction data 124 to issuer system 102. The raw transaction data 124 may include card receivable system records (from card receivable system 106), merchant payable system records (from merchant payable system 104), and settlement system records (from settlement system 108) which may be stored, respectively, as unlinked records of AR data 118, AP data 120, and GCS data 116. Transaction data 124 may be received by a data ingestion layer of issuer system 102 and may be sorted into spend and non-spend data (as described above) and stored as AR data 118, AP data 120, and GCS data 116. For example, spend data may include data elements such as the discount revenue earned on the transaction, the amount billed to the card member for each transaction, the amount billed to the card member, the currency of billing, the merchant settlement amount and the currency, and/or the like. Non-Spend data, for example, may include a cash advance amount, an annual card fee, a finance charge, interest fees, insurance fees, service fees, a fee type code, a fee description and name, a fee amount, a fee currency, a fee effective date, and/or the like.

Method 200 may further include generating a product-merchant data link between raw transaction data records based on a matching logic (step 208). Issuer system 102 may pass AR data 118, AP data 120, GCS data 116 sorted as spend data to matching engine 110 which may execute a matching logic to match unlinked records on the basis of one or more related data elements which may be common to one or more of the AR data 118, AP data 120, and GCS data 116. In this regard, matching engine 110 may link a card receivable system record, a merchant payable system record, and a settlement system record in accordance to the matching logic and store the linked records as match data 122. In various embodiments, issuer system 102 may receive a batch flow or a relatively continuous flow of raw transaction data 124 and may asynchronously call matching engine 110 to execute the matching logic. Issuer system 102 may pass the sorted spend data to the data readiness engine 126 prior to matching engine 110. Data readiness engine 126 may determine whether AR data 118, AP data 120, GCS data 116 records have previously been linked by matching engine 110 and, in turn, pass only unlinked records to matching engine 110. Data readiness engine may determine whether AR data 118, AP data 120, GCS data 116 records have previously been linked by matching engine 110 based on the match data 122 which may comprise a table of linked records.

In one example, matching engine 110 may match unlinked records on the basis of the transaction identifier and link a card receivable system record, a merchant payable system record, and a settlement system record where each of the records comprise the same transaction identifier (i.e., the transaction identifier matches between each of the card receivable system record, the merchant payable system record, and the settlement system record). Issuer system 102 may flag records linked in this manner as type 1 match data for storage as a subset of match data 122. A merchant payable system record and a settlement system record may be linked by matching engine 110 based on a common transaction identifier but not linked to a card receivable system record via the common transaction identifier. Stated another way, the transaction identifier may match between the merchant payable system record and the settlement system record. Issuer system 102 may flag records linked in this manner as type 2 match data for storage as a subset of match data 122.

In another example, matching engine 110 may match unlinked records on the basis of the transaction identifier between the card relievable system record and the settlement system record. A card receivable system record and a settlement system record may be linked by matching engine 110 based on a common transaction identifier and but not linked to a merchant payable system record where the transaction identifier matches between the card receivable system record and the settlement system record. Issuer system 102 may flag records linked in this manner as type 3 match data for storage as a subset of match data 122.

In yet another example, matching engine 110 may match unlinked records on the basis of the transaction identifier between the card receivable system record and the merchant payable system record. A card receivable system record and a merchant payable system record may be linked by matching engine 110 based on a common transaction identifier where the transaction identifier matches between the card receivable system record and the merchant payable system record. Issuer system 102 may flag records linked in this manner as type 4 match data for storage as a subset of match data 122.

In a final example, matching engine 110 may not match unlinked records on the basis of the transaction identifier. Issuer system 102 may flag records linked in this manner as type 5 match data for storage as a subset of match data 122. Stated another way, the system may classify a plurality of unlinked card receivable system records, settlement system records, and merchant payable system records for further analysis.

In this regard, issuer system 102 may construct a data set of related transaction records based on product-merchant data links (step 212). Issuer system 102 may construct a data set (e.g., match data 122) which may comprise linked AR data 118, AP data 120, GCS data 116 records or data elements. For example, match data 122 may comprise a transaction record with a customer identity linked to a card product identifier linked to a merchant identifier and linked to an earned discount revenue, which is matched and linked by matching engine 110 on the basis of a common transaction identifier. In this regard, issuer system 102 may determine discount revenue allocated to particular card product (via the unique card product identifier) and to a merchant (via the merchant identifier) based on the match data. Stated another way, issuer system 102 may enable a determination, for any given merchant, of a discount revenue and a spend data associated with each of a set of card products accepted by the merchant. Issuer system 102 may also enable a determination, or for any given customer, of a discount revenue associated with each of a set of card products used by the customer. For example, system 102 may link the match data to the card product identifier or to demographic elements of merchant data or customer data and, in this regard, data may be analyzed on the basis of the match data to reveal merchant demographics, customer demographics, discount billed volume, discount revenue allocated, and/or the like.

Furthermore, in response to segregating match data 122 by subtype (i.e., type 1 match through type 5 match), issuer system 102 may provide a robustness or reliability measure of the relationship between data elements of linked transaction records. Stated another way, issuer system 102 may determine a trust level for the product-merchant data link as a function of the type 1, type 2, type 3, type 4, and type 5 match data by linking with customer data or a card product identifier and/or the like. For type 1 linked records, card product attributes and merchant demographic attributes may be applied to the record to obtain data dimensionality for billed business, discount billed volume, gross discount revenue and FX conversion revenue. For type 2 linked records, card product attributes, client demographic attributes, and merchant demographic attributes may be applied to the record to obtain data dimensionality for discount billed business, gross discount revenue, and FX conversion revenue. For type 3 linked records, card product attributes, client demographic attributes, and merchant demographic attributes may be applied to the record to obtain data dimensionality for billed business and FX conversion revenue. For type 4 linked records, card product attributes, client demographic attributes, and merchant demographic attributes may be applied to the record to obtain data dimensionality for billed business, discount billed volume, and gross discount revenue.

For type 5 linked records, card product attributes, merchant demographic attributes and client demographic attributes may be applied to each of the unlinked records. For example, the attributes may be applied to an unlinked card receivable system record to obtain the data dimensionality for billed business. The attributes may be applied to unlinked settlement system records to obtain the data dimensionality for FS conversion revenue. The attributes may be applied to unlinked merchant payable system records to obtain the data dimensionality for billed volume and gross discount revenue. As will be appreciated, matching engine 110 may link any number of unlinked records on the basis of a desired data element in order to investigate relationships of interest such as, for example, which customers spent how much at which merchants using what card products resulting in a breakdown of spend and revenue earned by card product and merchant.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems, methods and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In various embodiments, the system and method may include a graphical user interface for dynamically relocating/rescaling obscured textual information of an underlying window to become automatically viewable to the user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

As used herein, “satisfy,” “meet,” “match,” “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

The system or any components may integrate with system integration technology such as, for example, the ALEXA system developed by AMAZON. Alexa is a cloud-based voice service that can help you with tasks, entertainment, general information and more. All Amazon Alexa devices, such as the Amazon Echo, Amazon Dot, Amazon Tap and Amazon Fire TV, have access to the Alexa Voice Service. The system may receive voice commands via its voice activation technology, and activate other functions, control smart devices and/or gather information. For example, music, emails, texts, calling, questions answered, home improvement information, smart home communication/activation, games, shopping, making to-do lists, setting alarms, streaming podcasts, playing audiobooks, and providing weather, traffic, and other real time information, such as news. The system may allow the user to access information about eligible accounts linked to an online account across all Alexa-enabled devices.

The customer may be identified as a customer of interest to a merchant based on the customer's transaction history at the merchant, types of transactions, type of transaction account, frequency of transactions, number of transactions, lack of transactions, timing of transactions, transaction history at other merchants, demographic information, personal information (e.g., gender, race, religion), social media or any other online information, potential for transacting with the merchant and/or any other factors.

The phrases consumer, customer, user, account holder, account affiliate, cardmember or the like shall include any person, entity, business, government organization, business, software, hardware, machine associated with a transaction account, who buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

A record of charge (or “ROC”) may comprise any transaction or transaction data. The ROC may be a unique identifier associated with a transaction. Record of Charge (ROC) data includes important information and enhanced data. For example, a ROC may contain details such as location, merchant name or identifier, transaction amount, transaction date, account number, account security pin or code, account expiry date, and the like for the transaction. Such enhanced data increases the accuracy of matching the transaction data to the receipt data. Such enhanced ROC data is NOT equivalent to transaction entries from a banking statement or transaction account statement, which is very limited to basic data about a transaction. Furthermore, a ROC is provided by a different source, namely the ROC is provided by the merchant to the transaction processor. In that regard, the ROC is a unique identifier associated with a particular transaction. A ROC is often associated with a Summary of Charges (SOC). The ROCs and SOCs include information provided by the merchant to the transaction processor, and the ROCs and SOCs are used in the settlement process with the merchant. A transaction may, in various embodiments, be performed by a one or more members using a transaction account, such as a transaction account associated with a gift card, a debit card, a credit card, and the like.

Distributed computing cluster may be, for example, a Hadoop® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/. For more information on big data management systems, see U.S. Ser. No. 14/944,902 titled INTEGRATED BIG DATA INTERFACE FOR MULTIPLE STORAGE TYPES and filed on Nov. 18, 2015; U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and filed on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

A “consumer profile” or “consumer profile data” may comprise any information or data about a consumer that describes an attribute associated with the consumer (e.g., a preference, an interest, demographic information, personally identifying information, and the like).

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by Artificial Intelligence (AI) or Machine Learning. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory or in-memory (non-spinning) hard drives. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS, EDB® Postgres Plus Advanced Server® (PPAS),etc.). In various embodiments, the server may include web servers (e.g. APACHE, IIS, GWS, SUN JAVA® SYSTEM WEB SERVER, JAVA Virtual Machine running on LINUX or WINDOWS).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS®/CE/Mobile, OS2, UNIX®, LINUX®, SOLARIS®, MacOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit,” “debit” or “debiting” refers to either causing the debiting of a stored value or prepaid card-type financial account, or causing the charging of a credit or charge card-type financial account, as applicable.

Phrases and terms similar to an “item” may include any good, service, information, experience, entertainment, data, offer, discount, rebate, points, virtual currency, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, blockchain, object-oriented structure and/or any other database configurations. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), MongoDB®, Redis®, Apache Cassandra®, HBase by APACHE®, MapR-DB, or any other suitable database product. Moreover, the databases may be organized in any suitable manner, for example, as data tables or lookup tables. Each record may be a single file, a series of files, a linked series of data fields or any other data structure.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, and symmetric and asymmetric cryptosystems. The systems and methods may also incorporate SHA series cryptographic methods as well as ECC (Elliptic Curve Cryptography) and other Quantum Readable Cryptography Algorithms under development.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, Ruby, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference. For example, representational state transfer (REST), or RESTful, web services may provide one way of enabling interoperability between applications.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQTM (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, JAVASCRIPT Object Notation (JSON), VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

In various embodiments, the software elements of the system may also be implemented using Node.js®. Node.js® may implement several modules to handle various core functionalities. For example, a package management module, such as npm®, may be implemented as an open source library to aid in organizing the installation and management of third-party Node.js® programs. Node.js® may also implement a process manager, such as, for example, Parallel Multithreaded Machine (“PM2”); a resource and performance monitoring tool, such as, for example, Node Application Metrics (“appmetrics”); a library module for building user interfaces, such as for example ReachJS®; and/or any other suitable and/or desired module.

As used herein, the term “end user,” “consumer,” “customer,” “cardmember,” “business” or “merchant” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet®, Veriphone®, Discover Card®, PayPal®, ApplePay®, GooglePay®, private networks (e.g., department store networks), and/or any other payment networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

Referring now to FIG. 2 the process flows and screenshots depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 2, but also to the various system components as described above with reference to FIG. 1.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Phrases and terms similar to a “party” may include any individual, consumer, customer, group, business, organization, government entity, transaction account issuer or processor (e.g., credit, charge, etc), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account,” “account number,” “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The system may include or interface with any of the foregoing accounts, devices, and/or a transponder and reader (e.g. RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

In yet another embodiment, the transponder, transponder-reader, and/or transponder-reader system are configured with a biometric security system that may be used for providing biometrics as a secondary form of identification. The biometric security system may include a transponder and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000.” The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

In various embodiments, an account number may identify a consumer. In addition, in various embodiments, a consumer may be identified by a variety of identifiers, including, for example, an email address, a telephone number, a cookie id, a radio frequency identifier (RFID), a biometric, and the like.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “transaction account,” “financial transaction instrument,” “transaction instrument” and/or the plural form of these terms may be used interchangeably throughout to refer to a financial instrument. Phrases and terms similar to “transaction account” may include any account that may be used to facilitate a financial transaction.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “payment processor” may include a company (e.g., a third party) appointed (e.g., by a merchant) to handle transactions. A payment processor may include an issuer, acquirer, authorizer and/or any other system or entity involved in the transaction process. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

Phrases similar to “vendor software” or “vendor” may include software, hardware and/or a solution provided from an external vendor (e.g., not part of the merchant) to provide value in the payment process (e.g., risk assessment).

An “acquirer” as used herein may include an entity that markets, installs, and supports POS transaction card acceptance at SEs, and typically negotiate a contract with the SE to accept certain brands of cards. A “card” as used herein may include a transaction instrument such as a charge card, credit card, debit card, awards card, prepaid card, telephone card, smart card, magnetic stripe card, bar code card, transponder, radio frequency card, electronic token, and/or the like having or describing an account number, which cardholders typically present to Service Establishments (SEs), as part of a transaction, such as a purchase. An “account number,” as used herein, includes any device, code, number, letter, symbol, digital certificate, smart chip, digital signal, analog signal, biometric or other identifier/indicia suitably configured to allow the consumer to interact or communicate with the system, such as, for example, authorization/access code, personal identification number (PIN), Internet code, other identification code, and/or the like which is optionally located on card. The account number may be distributed and stored in any form of plastic, electronic, magnetic, radio frequency, wireless, audio and/or optical device capable of transmitting or downloading data from itself to a second device. A customer account number may be, for example, a sixteen-digit credit card number, although each credit provider has its own numbering system, such as the fifteen-digit numbering system used by American Express. Each company's credit card numbers comply with that company's standardized format such that the company using a sixteen-digit format will generally use four spaced sets of numbers, as represented by the number “0000 0000 0000 0000.” The first five to seven digits are reserved for processing purposes and identify the issuing bank, card type and etc. In this example, the last sixteenth digit is used as a sum check for the sixteen-digit number. The intermediary eight-to-ten digits are used to uniquely identify the customer.

A “cardmember” as used herein may include an entity, typically an individual person or corporation, that has been issued a card or is authorized to use a card. An “issuer” as used herein may include a bank or other financial institution typically operating under regulations of a card issuing association or entity and which issues cards to cardmembers under a cardmember agreement for a cardmember account.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method, comprising:
receiving, by a computer based system, a request to generate a product-merchant data linkage;
receiving, by the computer based system, a raw data set comprising unlinked records;
sorting, by the computer based system, the raw data set into spend data and non-spend data;
generating, by the computer based system, the product-merchant data linkage based on a matching logic and the spend data; and
constructing, by the computer based system, a linked data set wherein the unlinked records are linked on the basis of the product-merchant data linkage.

2. The method of claim 1, wherein the generating the product-merchant data linkage comprises:
matching, by the computer based system, the unlinked records on the basis of a transaction identifier;
linking, by the computer based system, a card receivable system record, a merchant payable system record, and a settlement system record,
wherein the transaction identifier matches between each of the card receivable system record, the merchant payable system record, and the settlement system record; and
storing, by the computer based system, the linked records as a match data.

3. The method of claim 2, further comprising:
linking, by the computer based system, the merchant payable system record and the settlement system record,
wherein the transaction identifier matches between the merchant payable system record and the settlement system record; and
storing, by the computer based system, the linked records as match data.

4. The method of claim 3, further comprising:
linking, by the computer based system, the card receivable system record and the settlement system record,
wherein the transaction identifier matches between the card receivable system record and the settlement system record; and
storing, by the computer based system, the linked records as match data.

5. The method of claim 4, further comprising:
linking, by the computer based system, the card receivable system record and the merchant payable system record,
wherein the transaction identifier matches between the card receivable system record and the merchant payable system record; and
storing, by the computer based system, the linked records as match data.

6. The method of claim 5, further comprising:
classifying, by the computer based system, a plurality of unlinked card receivable system records, settlement system records, and merchant payable system records; and
storing, by the computer based system, the classified unlinked records as match data.

7. The method of claim 6, further comprising:
linking, by the computer based system, the match data to at least one of a card product identifier, a merchant data, or a customer data; and
determining, by the computer based system, a discount revenue allocated to a card product and a merchant based on the match data.

8. A system comprising:
a processor; and
a tangible, non-transitory memory configured to communicate with the processor,
the tangible, non-transitory memory having instructions stored thereon that, in response to execution by the processor, cause the processor to perform operations comprising:
receiving, by the processor, a request to generate a product-merchant data linkage;
receiving, by the processor, a raw data set comprising unlinked records;
sorting, by the processor, the raw data set into spend data and non-spend data;
generating, by the processor, the product-merchant data linkage based on a matching logic and the spend data; and
constructing, by the processor, a linked data set wherein the unlinked records are linked on the basis of the product-merchant data linkage.

9. The system of claim 8, wherein the generating the product-merchant data linkage comprises:
matching, by the processor, the unlinked records on the basis of a transaction identifier;
linking, by the processor, a card receivable system record, a merchant payable system record, and a settlement system record,
wherein the transaction identifier matches between each of the card receivable system record, the merchant payable system record, and the settlement system record; and
storing, by the processor, the linked records as a match data.

10. The system of claim 9, wherein the operations further comprise:
matching, by the processor, the unlinked records on the basis of the transaction identifier;
linking, by the processor, the merchant payable system record and the settlement system record,
wherein the transaction identifier matches between the merchant payable system record and the settlement system record; and
storing, by the processor, the linked records as match data.

11. The system of claim 10, wherein the operations further comprise:
linking, by the processor, the card receivable system record and the settlement system record,
wherein the transaction identifier matches between the card receivable system record and the settlement system record; and
storing, by the processor, the linked records as match data.

12. The system of claim 11, wherein the operations further comprise:
linking, by the processor, the card receivable system record and the merchant payable system record,
wherein the transaction identifier matches between the card receivable system record and the merchant payable system record; and
storing, by the processor, the linked records as match data.

13. The system of claim 12, wherein the operations further comprise:
classifying, by the processor, a plurality of unlinked card receivable system records, settlement system records, and merchant payable system records; and
storing, by the processor, the classified unlinked records as match data.

14. The system of claim 13, wherein the operations further comprise:
linking, by the processor, the match data to at least one of a card product identifier, a merchant data, or a customer data; and
determining, by the processor, a discount revenue allocated to a card product and a merchant based on the match data.

15. An article of manufacture including a non-transitory, tangible computer readable storage medium having instructions stored thereon that, in response to execution by a computer based system, cause the computer based system to perform operations comprising:
receiving, by a computer based system, a request to generate a product-merchant data linkage;
receiving, by the computer based system, a raw data set comprising unlinked records;
sorting, by the computer based system, the raw data set into spend data and non-spend data;
generating, by the computer based system, the product-merchant data linkage based on a matching logic and the spend data; and
constructing, by the computer based system, a linked data set wherein the unlinked records are linked on the basis of the product-merchant data linkage.

16. The article of manufacture of claim 15, wherein the generating the product-merchant data linkage comprises:
matching, by the computer based system, the unlinked records on the basis of a transaction identifier;
linking, by the computer based system, a card receivable system record, a merchant payable system record, and a settlement system record,
wherein the transaction identifier matches between each of the card receivable system record, the merchant payable system record, and the settlement system record; and
storing, by the computer based system, the linked records as a match data.

17. The article of manufacture of claim 16, wherein the operations further comprise:
linking, by the computer based system, the merchant payable system record and the settlement system record,
wherein the transaction identifier matches between the merchant payable system record and the settlement system record; and
storing, by the computer based system, the linked records as match data.

18. The article of manufacture of claim 17, wherein the operations further comprise:
linking, by the computer based system, the card receivable system record and the settlement system record,
wherein the transaction identifier matches between the card receivable system record and the settlement system record; and
storing, by the computer based system, the linked records as match data.

19. The article of manufacture of claim 18, wherein the operations further comprise:
linking, by the computer based system, the card receivable system record and the merchant payable system record,
wherein the transaction identifier matches between the card receivable system record and the merchant payable system record; and
storing, by the computer based system, the linked records as match data.

20. The article of manufacture of claim 19, wherein the operations further comprise:
classifying, by the computer based system, a plurality of unlinked card receivable system records, settlement system records, and merchant payable system records; and
storing, by the computer based system, the classified unlinked records as match data.
